(19) United States
(12) Patent Application Publication
(10) Pub. No.: US 2017/0089529 A1
(43) Pub. Date: Mar. 30, 2017

(54) TRACK LIGHTING DEVICE

(71) Applicant: DONGGUAN YINGHUI LIGHTING CO., LTD., Dongguan (CN)

(72) Inventor: Shuisheng XU, Dongguan (CN)

(21) Appl. No.: 15/274,001

(22) Filed: Sep. 23, 2016

(30) Foreign Application Priority Data
Sep. 24, 2015 (CN) 201520746604.0

(51) Int. Cl. F21S 4/20; F21V 23/04; H05B 37/02; F21V 23/02

(52) U.S. Cl. CPC F21S 4/20; F21V 23/02; F21V 23/04; H05B 37/0272

(57) ABSTRACT

The patent provides a track lighting device, which includes a track strip, a power pack which is installed at one end of the track strip and lighting devices which are provided on the track strip slidably, wherein the power pack includes a shell, an electrically conductive elastic sheet, an elastic sheet cover, a shell cover and a control circuit; and the control circuit is provided in the shell, the shell cover covers the bottom surface of the shell, the electrically conductive elastic sheet is provided on the elastic sheet cover, and the electrically conductive elastic sheet and the elastic sheet cover are combinatively installed below the joint portion. The installed elastic sheet cover, electrically conductive elastic sheet and joint portion are all inlayed from the one end of the track strip and are inserted in the track strip.

### FIELD OF THE INVENTION

The present patent relates to a lighting device, in particular to a track lighting device.

### BACKGROUND OF THE INVENTION

The traditional track light is equipped with a corresponding control switch, and such switch is more complicated in installation, brings many inconveniences to installation and use of the track light and consumes relatively high labor cost. In addition, when numerous track lights are provided in a space environment, the environments where the track lights to be turned on are located and the series categories of the track lights are often confused. On-off control of different series of track lights is controlled against different loops in terms of control over the track lights, thus enabling the user to feel complicated and hardly-remembered in the control memory and very inconvenient to operate. Furthermore, the switch of the traditional track light is controlled simply between “on” and “off”, and the brightness of the track light cannot be adjusted to not facilitate energy saving and emission reduction.

### SUMMARY OF THE INVENTION

Based on this, it is necessary to provide a track lighting device which is fast to mount and has a dimming function against the defects of the prior art.

The track lighting device comprises a track strip, a power pack which is installed at one end of the track strip and lighting devices which are provided on the track strip slidably, wherein the lighting devices can move on the track strip freely, and a joint portion is convexly provided at one end of the power pack; the power pack includes a shell, an electrically conductive elastic sheet, an elastic sheet cover, a shell cover and a control circuit, wherein the control circuit is provided in the shell, the shell cover covers the bottom surface of the shell, the electrically conductive elastic sheet is provided on the elastic sheet cover, and one end of the electrically conductive elastic sheet is connected to the control circuit; and the electrically conductive elastic sheet and the elastic sheet cover are combinatively installed below the joint portion. The installed elastic sheet cover, electrically conductive elastic sheet and the joint portion are all inlayed from the one end of the track strip and are inserted in the track strip. The other end of the electrically conductive elastic sheet is connected to a circuit inside the track strip. The power pack is wirelessly connected to an external control terminal which is equipped with corresponding APP and can send a control command to the corresponding APP so as to control the opening and closing, and brightness adjusting of the lighting devices.

Further, the control circuit comprises a power module, a switch control circuit, a dimming module and a wireless communication module, wherein the power module is configured to supply power to the dimming module and the wireless communication module, and the dimming module and a switch module are coupled to the wireless communication module respectively.

Further, a plurality of lighting devices are installed on the track strip, and the control terminal can wirelessly control a plurality of lighting devices on the same track strip simultaneously.

Further, the control terminal is a mobile phone or a tablet computer.

Further, the track strip is strip-shaped, the bottom surface of the track strip is provided with a spacing groove which penetrates through the track strip along the extension direction of the track strip, and the lighting devices are installed in the spacing groove and can slide in the spacing groove freely.

Further, the installed joint portion, elastic sheet cover and electrically conductive elastic sheet are all inlayed in the spacing groove of the track strip.

Compared with the prior art, the track lighting device of the present patent is equipped with the power pack, the control circuit, the wireless communication module and the like, wherein the power pack can be fast installed at the front end of the track strip, and the control terminal can directly control the opening and closing, and brightness adjusting of the lighting devices; no switch needs to be installed additionally, such that manual work and material cost are saved; and furthermore, the same control terminal can not only wirelessly control a plurality of lighting devices on the same track strip, but also control single lighting device, and operates more portably.

### BRIEF DESCRIPTION OF THE DRAWINGS

FIG. 1 is a stereoscopic schematic diagram of the track lighting device of the present patent;

FIG. 2 is a structural schematic diagram from the other angle of the track lighting device as shown in FIG. 1, in which the lighting devices are not displayed;

FIG. 3 is an exploded schematic diagram of the track lighting device as shown in FIG. 2; and

FIG. 4 is a schematic diagram when the track lighting device of the present patent is connected with the control terminal through signals.

### DETAILED DESCRIPTIONS OF THE PREFERRED EMBODIMENTS

In order to make the purpose, the technical solution and the advantages of the present patent more clearly, the present patent is further illustrated in details below in conjunction with the drawings and the embodiments.

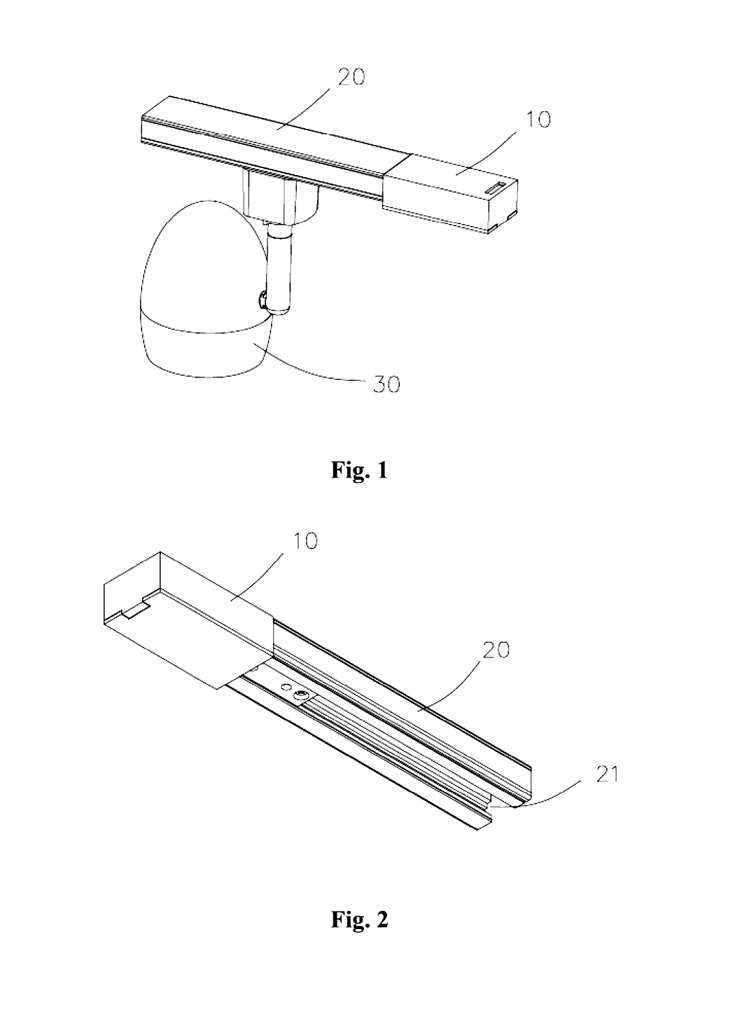

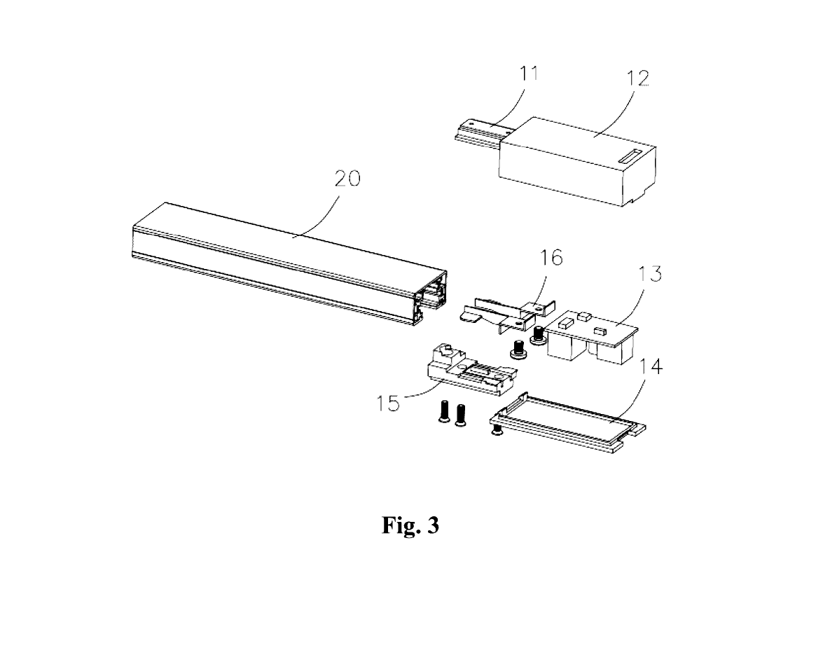

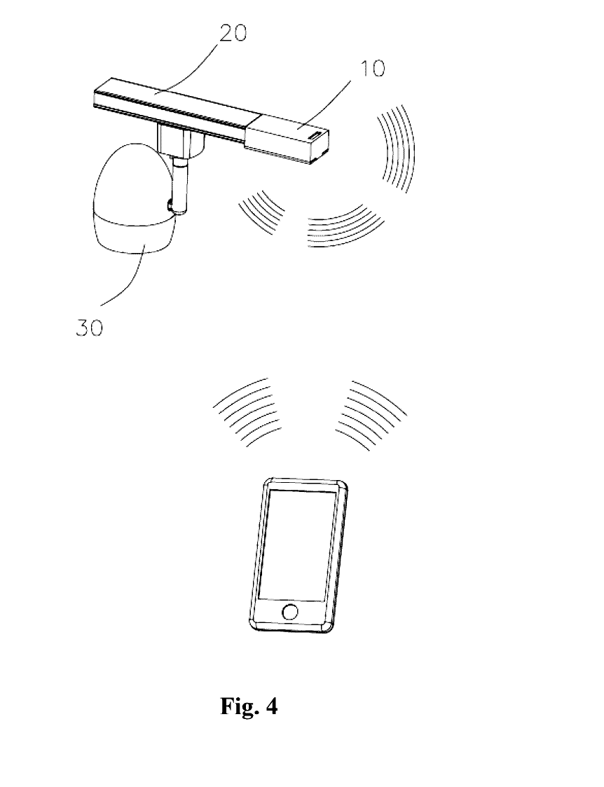

FIGS. 1-4 illustrate a track lighting device provided by the present patent. The track lighting device comprises a track strip 20, a power pack 10 which is installed at one end of the track strip 20 and lighting devices 30 which are provided on the track strip 20 slidably, wherein the lighting device 30 can move on the track strip freely. The power pack is wirelessly connected to an external terminal which may be a mobile phone, a tablet computer or the like. The control terminal is equipped with corresponding APP and can send a control command to the corresponding APP, and the power pack 10 receives the control command sent from the control terminal so as to control the opening and closing, and brightness adjusting of the lighting devices 30. One or more lighting devices 30 may be installed on the track strip 20, and the control terminal may not only wirelessly control a plurality of lighting devices 30 on the same track strip 20, but also control single lighting device 30.

The track strip 20 is strip-shaped. The bottom surface of the track strip 20 is provided with a spacing groove 21 which penetrates through the track strip 20 along the extension direction of the track strip 20. Each lighting device 30 is provided with a clamping structure which is fitted to the spacing groove. The lighting devices 30 may move in the spacing groove 21 freely. A joint portion 11 is convexly provided at one end of the power pack 10 and is inlayed into the spacing groove 21 of the track strip 20 to fix the power pack 10 on the track strip 20.

The power pack 10 includes a shell 12, an electrically conductive elastic sheet 16, an elastic sheet cover 15, a shell cover 14 and a control circuit 13, wherein the control circuit 13 is provided in the shell 12, the shell cover 14 covers the bottom surface of the shell 12, the electrically conductive elastic sheet 16 is provided on the elastic sheet cover 15, and one end of the electrically conductive elastic sheet 16 is connected to the control circuit 13; and the elastic sheet cover 15 is combinatively installed below the joint portion 11. The installed elastic sheet cover 15, electrically conductive elastic sheet 16 and joint portion 11 are all inlayed from the one end of the track strip 20 and are inserted in the spacing groove 21. The other end of the electrically conductive elastic sheet 16 is connected to a circuit inside the track strip 20.

The control circuit 13 comprises a power module, a voltage sensing module, a dimming module and a wireless communication module, wherein the power module is configured to supply power to the dimming module and the wireless communication module, and the dimming module is coupled to the wireless communication module. A connection mode of the wireless communication module and the control terminal may be Bluetooth, Zigbee, WiFi, NFC or the like. The wireless communication module can receive a control command sent from the corresponding control terminal (e.g., brightening, darkening, turn-on or turn-off). Specifically, the wireless communication module receives a control command sent from the corresponding control terminal, generates a dimming control signal and an on-off control signal according to the control command and transmits the signals to the dimming module, and the dimming module drives the lighting devices according to the dimming control signal and the on-off control signal.

During installation, the power pack 10 is directly inserted into one end of the track strip, and is very convenient to disassemble and assemble, and capable of being fast mounted.

After the power module is connected to an external power supply, an alternating-current voltage 100-240V AC is filtered, and then a direct-current voltage is converted into a high-frequency impulse direct current and is then rectified and filtered after voltage reduction to obtain a 5V direct-current voltage, and the 5V direct-current voltage is divided into two paths for supplying power to the dimming module and a wireless receiving module respectively. The voltage sensing module detects and adjusts the output voltage, and when the output voltage is too low, a duty ratio of a PMC signal is increased, and on the contrary, when the output voltage is too high, the duty ratio of the PMC signal is reduced, such that the output voltage is more stable. The wireless receiving module receives a signal sent from the control terminal, and then controls the dimming module to realize dimming by outputting the PWM signal.

From the above, the track lighting device of the present patent is equipped with the power pack 10 and the control circuit 13, wherein the power pack 10 can be fast installed at the front end of the track strip 20, and the control terminal 13 is wirelessly connected to the control terminal and can directly control the opening and closing, and brightness adjusting of the lighting devices 30. No switch needs to be installed additionally, such that manual work and material cost are saved. Furthermore, the same control terminal can not only wirelessly control a plurality of lighting devices 30 on the same track strip 20, but also control single lighting device, and operates more portably.

The embodiments aforementioned just express an implementation of the present patent, and its description is more specific and detailed, but may not be thereby interpreted to limit the patent scope of the present patent. It should be pointed out that, for the common skilled in the art, a plurality of variations and modifications may be made on the premise of not departing from the concept of the present patent and should be considered to fall into the scope of the present patent. Therefore, the patent protection scope of the present patent should be subject to the attached claims.

What is claimed is:

1. A track lighting device, comprising a track strip, a power pack which is installed at one end of the track strip and lighting devices which are provided on the track strip slidably, wherein the lighting device can move on the track strip freely, and a joint portion is convexly provided at one end of the power pack; the power pack includes a shell, an electrically conductive elastic sheet, an elastic sheet cover, a shell cover and a control circuit, wherein the control circuit is provided in the shell, the shell cover covers the bottom surface of the shell, the electrically conductive elastic sheet is provided on the elastic sheet cover, and one end of the electrically conductive elastic sheet is connected to the control circuit; and the electrically conductive elastic sheet and the elastic sheet cover are combinatively installed below the joint portion; the installed elastic sheet cover, electrically conductive elastic sheet and joint portion are all inlayed from the one end of the track strip and are inserted in the track strip; the other end of the electrically conductive elastic sheet is connected to a circuit inside the track strip; the power pack is wirelessly connected to an external control terminal which is equipped with corresponding APP and can send a control command to the corresponding APP so as to control the opening and closing, and brightness adjusting of the lighting devices.

2. The track lighting device of claim 1, wherein the control circuit comprises a power module, a switch control circuit, a dimming module and a wireless communication module, the power module is configured to supply power to the dimming module and the wireless communication module, and the dimming module and a switch module are coupled to the wireless communication module respectively.

3. The track lighting device of claim 1, wherein a plurality of lighting devices are installed on the track strip, and the control terminal can wirelessly control a plurality of lighting devices on the same track strip simultaneously.

4. The track lighting device of claim 1, wherein the control terminal is a mobile phone or a tablet computer.

5. The track lighting device of claim 1, wherein the track strip is strip-shaped, the bottom surface of the track strip is provided with a spacing groove which penetrates through the track strip along the extension direction of the track strip, and the lighting devices are installed in the spacing groove and can slide in the spacing groove freely.

6. The track lighting device of claim 1, wherein the installed joint portion, elastic sheet cover and electrically conductive elastic sheet are all inlayed in the spacing groove of the track strip.
